(19) United States
(12) Patent Application Publication
(10) Pub. No.: US 2006/0243227 A1
(43) Pub. Date: Nov. 2, 2006

(54) VARIABLE-COMPRESSION ENGINE

(76) Inventor: Christopher G. Greve, Covington, LA (US)

Correspondence Address: LAITRAM, L.L.C.;LEGAL DEPARTMENT, 220 LAITRAM LANE, HARAHAN, LA, 70123, US

(21) Appl. No.: 10/908,139

(22) Filed: Apr. 28, 2005

(51) Int. Cl. F02B 75/04

(52) U.S. Cl. 123/48 B

(57) ABSTRACT

A variable-compression engine in which each piston is adjustable attached to the end of a connecting rod. Each piston is internally threaded to receive an adapter threaded into the piston's bore. The adapter is rotatably attached to an end of the connecting rod. Elongated teeth formed on the exterior of the piston engage mating teeth of a drive gear directly or through an intervening collar. A stepper motor drives the drive gear to rotate the piston, which advances along the threads of the adapter. As the piston advances along the threads, the piston's position relative to the end of the connecting rod changes. This change offsets the stroke of the piston and, consequently, the engine's compression ratio. Spiral notches in the piston head provide clearance for the opening of intake and exhaust valves.

### BACKGROUND

The invention relates generally to internal combustion engines and, more particularly, to a variable-compression engine with a piston helically rotatable about an adapter connected to an end of a connecting rod.

Dynamically varying the compression ratio of an engine with load can increase the engine's efficiency, which leads to better gas mileage and reduced emissions. The compression ratio can be varied in a number of ways, including: (1) raising and lowering the cylinder relative to the crankshaft; (2) rotating the cylinder relative to the crankshaft; (3) opening or closing the entrance to an auxiliary combustion chamber; (4) raising and lowering the crankshaft via eccentric bearings; and (5) changing the effective length of the connecting rod with adjustable intermediate linkages. But most of these examples are hydraulically operated and require that the engine be running or otherwise need a separate battery-operated pump. Most also move against the working direction of the piston.

### SUMMARY

One version of a variable-compression engine overcoming these shortcomings and embodying features of the invention comprises a piston movable back and forth in a cylinder. A piston skirt extends between a closed top end of the piston and an open bottom end. The skirt forms an interior face with a helically threaded portion and an exterior face having a toothed structure in the form of circumferentially spaced teeth extending parallel to the axis of the cylinder. An adapter for connecting to an end of a connecting rod has helical threads that engage the threaded portion of the interior face of the piston skirt. Compression adjustment means engage the teeth on the exterior face of the piston skirt to rotate the piston helically on the helical threads of the adapter to adjust the compression ratio of the cylinder. The compression adjustment means may be realized, for example, as a rack gear having teeth meshing with the teeth on the exterior face of the skirt or as a timing belt extending partway around the piston with teeth regularly spaced to mate with the teeth on the exterior face of the skirt. The compression adjustment means could alternatively be realized as a collar with an outer periphery and a central bore receiving the piston. Internal teeth bounding the bore mate with the toothed structure on the exterior face of the piston skirt. External teeth are formed on the periphery of the collar. A gear having teeth engaging the external teeth on the collar rotates the collar and, consequently, the encircled piston to adjust the compression ratio of the cylinder.

Another version of a variable-compression engine comprises a cylinder and a piston that can reciprocate in the cylinder along the cylinder's axis. The piston has a cylindrical skirt that extends between a closed top end and an open bottom end of the piston. The skirt bounds a threaded interior bore and has a geared exterior. An adapter for connecting to an end of a connecting rod has helical threads and is received in the threaded interior bore. An adjustment gear meshes with the geared exterior of the piston skirt. The adjustment gear is selectively actuated to apply a tangential force to the piston skirt to rotate the piston in the cylinder helically on the helical threads of the adapter. In this way, the adjustment gear adjusts the compression ratio of the cylinder.

In yet another version of a variable-compression engine, a piston is reciprocatable in a cylinder having a closed head end. The piston travels in a stroke direction between a top dead center position nearer the head end of the cylinder and a bottom dead center position farther from the head end. The piston has a top end nearer the head end of the cylinder and a cylindrical skirt bounding a threaded interior bore that terminates in a blind end at the top end of the piston. The skirt has an exterior with a plurality of circumferentially spaced elongated teeth extending parallel to the stroke direction. Parallel channels are formed between consecutive teeth. A cylindrical adapter for connecting to an end of a connecting rod has threads on a cylindrical periphery. The adapter is received in the threaded interior bore of the piston. Drive lugs separated by gaps are arranged to engage the exterior of the piston skirt. One or more of the drive lugs are each received in an individual channel on the skirt. One or more of the teeth are each received in an individual gap between consecutive drive lugs. In this way, the piston can reciprocate in the stroke direction along the drive lugs. The drive lugs are selectively moved to apply a tangential force on the piston skirt by pushing against the elongated teeth. The tangential force causes the piston to rotate in the cylinder and ride along the threads of the cylindrical adapter to change the top and bottom dead center positions of the piston.

Yet another version of a variable-compression engine comprises a piston reciprocatable in a cylinder along the cylinder's axis. The piston has a cylindrical skirt that extends between a closed top end of the piston and an open bottom end. The skirt bounds a threaded interior bore and has a plurality of teeth forming a spur gear centered on the cylinder axis. An adapter for connecting to an end of a connecting rod has helical threads and is received in the threaded interior bore of the position. An adjustment gear meshing with the spur gear is selectively actuated to rotate the piston in the cylinder helically on the helical threads of the adapter to adjust the compression ratio of the cylinder.

Yet another version of variable-compression engine comprises a cylinder, a crankshaft, a connecting rod, a piston, and an adapter. The connecting rod is connected at a first end to a wrist pin on the adapter and at a second end to the crankshaft. The piston includes a skirt that forms a spur gear surrounding a threaded piston bore. The piston is threaded onto the threaded periphery of the adapter and received in the cylinder. The second end of the connecting rod extends from the bore in the cylinder to the crank shaft. Rotation of the spur gear causes the piston to ride along the threads of the adapter to adjust the distance between the piston and the second end of the connecting rod.

In another version of a variable-compression engine, a piston defines an axis and includes a skirt with a helically threaded region formed along an interior of the skirt. An adapter for attaching to an end of a connecting rod has a threaded periphery engaged with the helically threaded region of the piston skirt. The adapter can be displaced axially relative to the piston in the threaded region by rotation of the piston about the axis and the threaded movement of the piston on the adapter.

According to another aspect of the invention, a piston for a variable-compression engine, the piston comprises a piston head at one end and an open bottom at the other end. A piston skirt extends axially between the piston head and the open bottom and has an interior face with a helically threaded portion and an exterior face with a toothed structure in the form of parallel, circumferentially spaced teeth separated by axial channels.

In another aspect of the invention, a method for varying the compression ratio of an engine comprises: providing the skirt of a piston in an engine with internal threads; coupling one end of a connecting rod to the piston by pinning the end to an adapter threaded with the internal threads of the piston skirt; and rotating the piston to move it along the threads to change its position relative to the adapter and the end of the connecting rod.

### BRIEF DESCRIPTION OF THE DRAWINGS

These features and aspects of the invention, as well as its advantages, are better understood by reference to the following description, appended claims, and accompanying drawings, in which:

FIG. 1 is a partly cutaway view of a portion of the cylinder block and the cylinder head of a variable-compression engine embodying features of the invention and adjusted for maximum compression ratio;

FIG. 2 is a view as in FIG. 1 with the engine adjusted for minimum compression ratio;

FIG. 3 is a view of the engine of FIG. 1 with two pistons removed to show the rack gear;

FIG. 4 is a partly cutaway view of a single cylinder of the engine of FIG. 1;

FIG. 5 is a partly cutaway view of another version of variable-compression engine featuring a worm gear to adjust compression, with the cylinder block and the cylinder head not shown for clarity;

FIG. 6 is a pictorial view of yet another version of variable-compression engine featuring a serpentine timing belt to adjust compression, with the cylinder block and the cylinder head not shown for clarity;

FIG. 7 is a pictorial view of another version of a timing-belt-adjusted variable-compression engine, with the cylinder block and the cylinder head not shown for clarity;

FIG. 8 is a pictorial view of a piston usable in an engine as in FIGS. 1-7, with an adjustment collar; and

FIG. 9 is a pictorial view of an adjustable piston as in FIG. 8 with spiral notches in the piston head to accommodate intake and exhaust valves.

### DETAILED DESCRIPTION

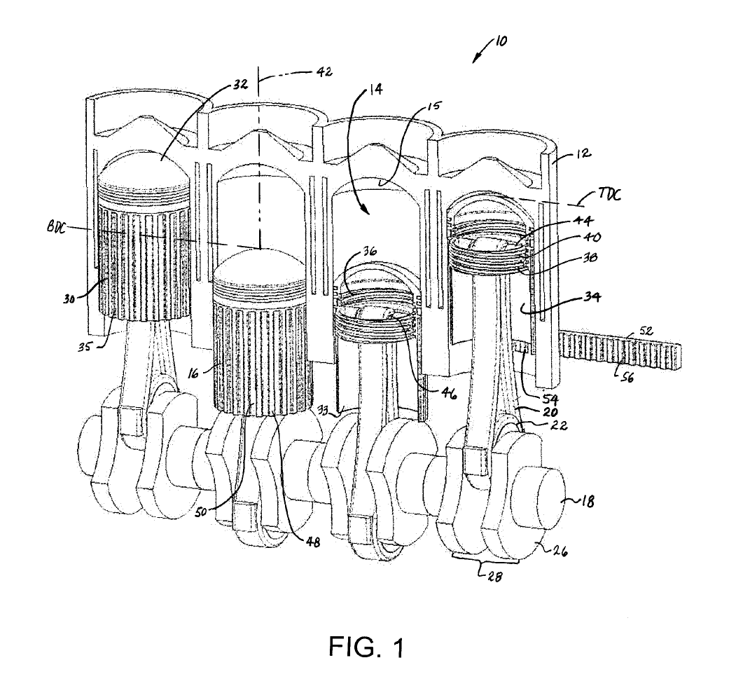

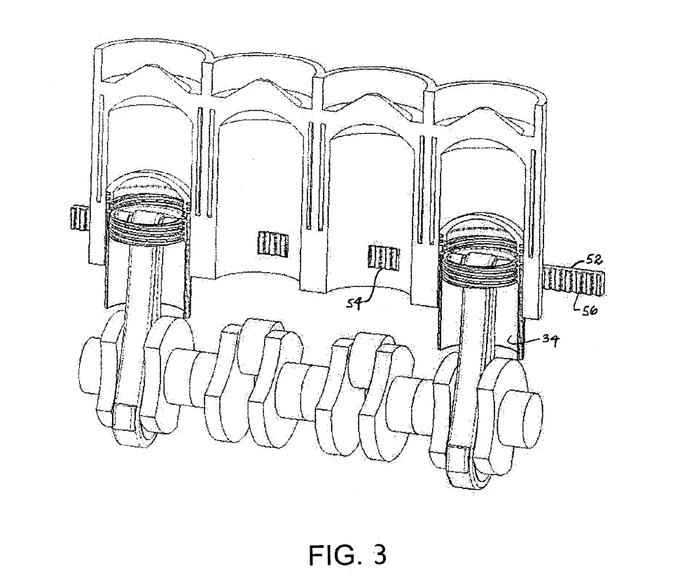

One version of a variable-compression engine embodying features of the invention is shown in FIGS. 1-4. For purposes of illustration, the engine 10 shown in the drawings is an in-line, four-cylinder engine, which includes a cylinder block and head 12 and four consecutive cylinders 14 terminating in closed head ends 15. (In the drawings, certain liberties were taken and details omitted for clarity. For example, the partial cylinder block and the cylinder head are shown as a monolithic structure, instead of as individual bolted-together parts separated by a head gasket. Their omission, along with the omission of intake and exhaust valves and other details common to conventional engines, is merely for the purpose of simplifying the illustrations and does not necessarily represent a deviation from standard engine design.) Pistons 16 in the cylinders are connected to a crankshaft 18 by connecting rods 20. A bore 22 at the crankshaft end of each connecting rod is rotatably mounted on a rod journal extending between a pair of counterweighted webs 26 forming a throw 28 of the crankshaft.

Each piston has a cylindrical skirt 30 that extends from a closed top end 32, or head, to an open bottom end 33. An interior face 34 of each piston skirt has a helically threaded portion 36 near the top end to form a threaded interior bore. A cylindrical adapter 38 has external threads 40 on its periphery that engage the threads on the interior face of the piston skirt. The interior face has more threads to give the adapter a range of axial positions along the piston in the direction of the cylinder axis 42. The adapter includes a diametrically arranged wrist pin 44 with a central journal rotatably received in a bore 46 at the piston end of the connecting rod.

The piston skirt includes a geared exterior face 35 in the form of circumferentially spaced, elongated teeth 48 extending parallel to the cylinder axis. The tooth structure on the skirt exterior defines a spur gear with parallel channels 50 between consecutive teeth. The external teeth on the piston skirt, together with the threaded connection of the piston to the adapter, permit the piston to be rotated on the adapter to adjust the stroke of the piston in the cylinder. One way this is done is with the rack gear 52 shown in FIGS. 1-4. Slots 54 in the sides of the cylinder block intersect the cylinder walls. The rack gear extends through the slots perpendicular to the cylinder axis, or stroke direction. Teeth 56 on the rack gear mesh with the geared exterior of the pistons. Acting as a pinion gear, the piston rotates as the rack is selectively moved by a motor, such as a stepper motor (not shown in FIGS. 1-4, but shown in other figures in conjunction with other compression adjustment schemes).

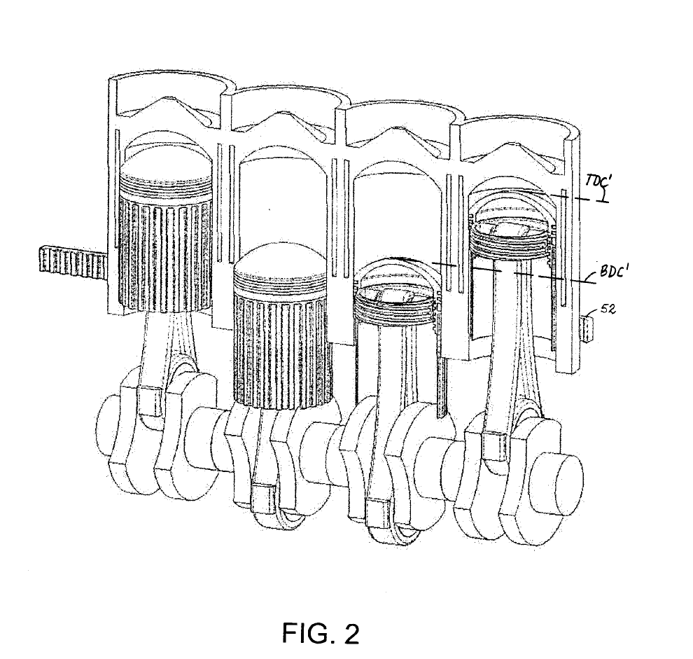

The compression ratio of the engine is adjusted by the rack gear. In FIG. 1, the engine is adjusted for a maximum compression ratio. The rack is shown at one extreme, with the adapter threaded into the piston's bore at the bottom of the threaded portion. This allows the piston to reciprocate in the cylinder between first top dead center position TDC close to the head end of the cylinder and a first bottom dead center position BDC. In FIG. 2, the rack 52 is shown in an opposite extreme position adjusting the engine for minimum compression. In moving from its position in FIG. 1 to its position in FIG. 2, the rack rotates the piston, which threads the adapter deeper into the piston's bore. In this condition, the cylinder's stroke is offset axially away from the head end of the cylinder. The stroke in FIG. 2 extends from a second top dead center position TDC′ to a second bottom dead center position BDC′. In this way, the compression ratio of the engine can be selectively adjusted by stepping the rack gear to a position between the two extremes.

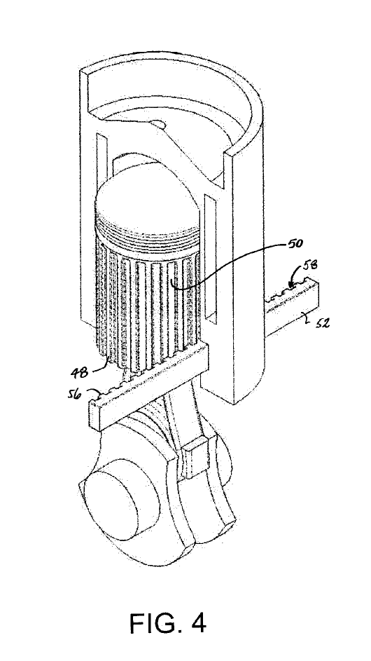

As shown in FIG. 4, the elongated teeth 48 with their parallel channels 50 mesh with the teeth 56 and their gaps 58 on the rack 52. As the rack is translated, the teeth on the skirt of the reciprocating piston engaged with the rack ride in the gaps between teeth on the rack gear. The engaged teeth on the rack that are received in the channels on the piston's skirt push against the piston's teeth and provide a tangential force that causes the piston to rotate on the threaded adapter, which displaces the adapter axially relative to the piston and, consequently, the ends of the stroke of the piston relative to the cylinder. Thus, the rack gear serves as means for adjusting the compression of the engine.

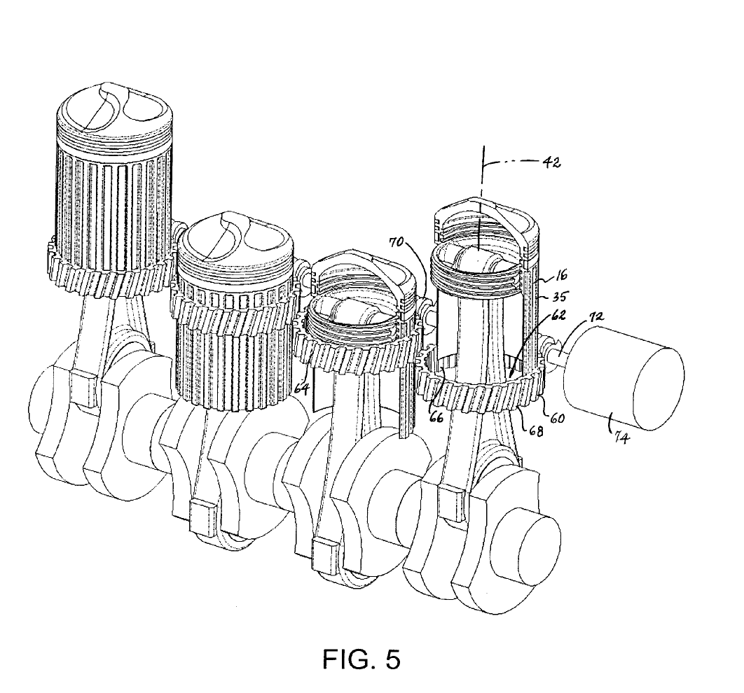

Another compression adjustment means is shown in FIG. 5. In this version of the engine, each piston 16 is surrounded by a collar 60. The collar, which may be made of metal or nylon, has a central bore 62 and an outer periphery 64. The collar, which is rotatably retained in the cylinder block, receives the piston in its central bore. Internal teeth 66 bounding the bore are elongated parallel to the cylinder axis 42 to mate with the geared exterior 35 of the piston skirt. External teeth 68 on the periphery of the collar are arranged oblique to the cylinder axis to engage the threads of a worm gear 70 coupled to the shaft 72 of a stepper motor 74. Rotation of shaft causes the worm gear to rotate the collar, which, in turn, rotates the piston. In this way, the stepper motor can be selectively energized to adjust the engine's compression ratio. When an electric stepper motor is used, rather than a hydraulic motor, the compression ratio can be adjusted even while the engine is not running. Of course, a similar stepper motor with an associated pinion gear could be used to engage and drive the rack gear in FIGS. 1-4.

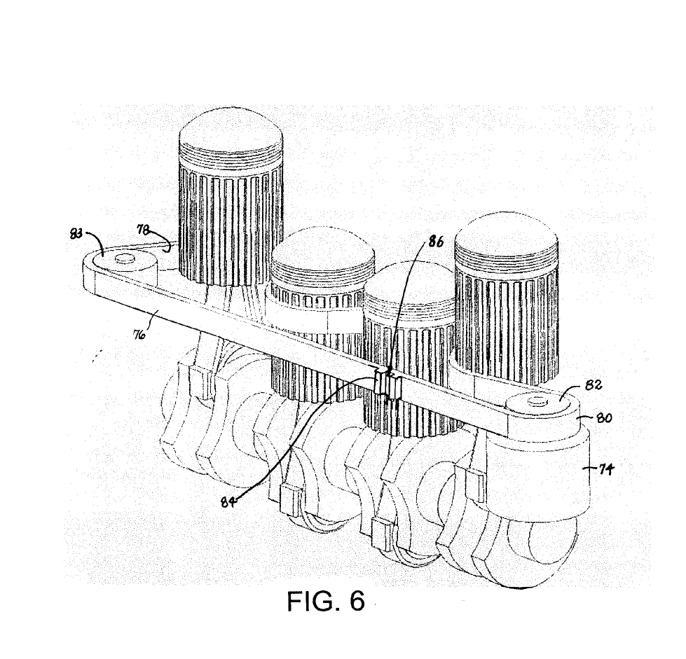

In the version shown in FIG. 6, a timing belt 76 acts as a compression adjustment means. The timing belt has a toothed interior side 78 and a toothed exterior side 80. The exterior and interior teeth could be made of nylon to withstand the hot and dynamic engine environment. The belt is trained around drive and idler pulleys 82, 83 and, like a snake, is wrapped partly around the skirts of the pistons through slots in the cylinder block (not shown). The exterior and interior sides of the serpentine belt include teeth, or drive lugs 84, separated by gaps 86. (For simplicity, only two of the exterior teeth and none of the similarly spaced interior teeth are shown in FIG. 6.) The exterior and interior sides of the belt engage the geared exteriors 35 of the piston skirts. Consecutive pistons are engaged by opposite sides and rotated in opposite directions. Consequently, the internal threads of consecutive pistons are oppositely formed, along with the threads of the associated adapters. A stepper motor 74 coupled to the drive pulley selectively steps the belt to rotate the pistons and adjust the engine's compression. Although the timing belt is shown driving the piston skirt directly, it could alternatively drive the piston through an intermediate collar with internal teeth parallel to the cylinder axis.

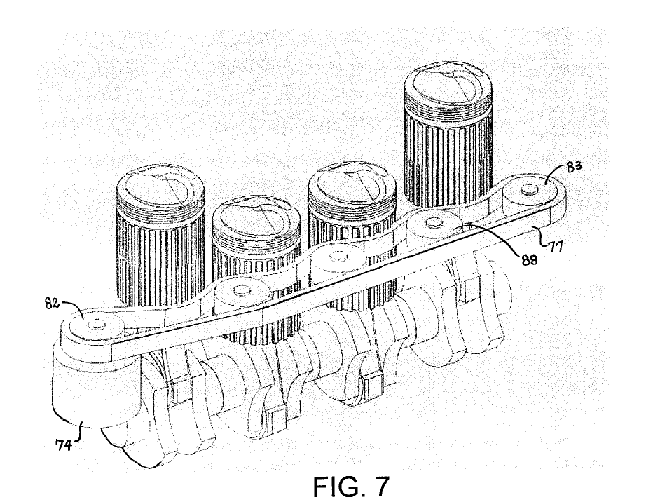

Another version of the variable-compression engine is shown in FIG. 7. In this engine, the pistons are rotated by a timing belt as in FIG. 6, but, in this version, the belt does not snake its way around the pistons. Instead, the timing belt 77, like the belt in FIG. 6, is maintained in contact with the toothed exterior of the pistons by rollers 88 bearing against the interior side 78 of the belt. The pressure of the rollers against the belt and their positions between consecutive cylinders pushes the exterior side 80 of the belt into engagement with a portion of the geared exterior of the piston skirt. A stepper motor 74 coupled to a toothed drive pulley 82 selectively advances the timing belt to rotate the pistons and adjust the compression. Slots in the cylinder block (not shown) admit the timing belt into the cylinders. A toothed or toothless idler pulley 83 guides the belt back to the drive pulley.

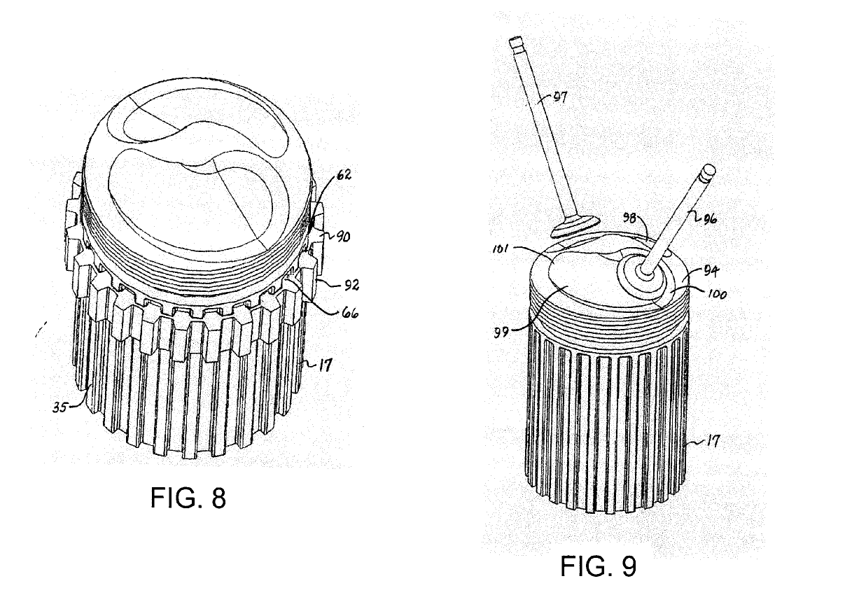

A piston 17 is shown in FIG. 8 encircled by an adjustment collar 90. The geared exterior face 35 of the piston skirt meshes with internal teeth 66 bounding the collar's bore 62. External teeth 92 on the periphery of the collar, unlike the oblique teeth in FIG. 5, extend parallel to the stroke of the piston. This makes the collar compatible with the rack gear of FIG. 1 and the timing belts of FIGS. 6 and 7. By engaging the entire circumference of the reciprocating piston and providing a stationary geared surface to the rack or timing belt, the collar may make for a more robust compression adjustment.

The piston 17 of FIG. 8 is shown in a top dead center position for maximum compression ratio. When a cylinder is adjusted for maximum compression, the top, head end 94 of the piston is close to intake and exhaust valves 96, 97. To prevent the valves from bumping into the piston head, a pair of spiral notches 98, 99 is formed in the piston head. Each notch tapers in depth circumferentially from a deep end 100 to an opposite shallow end 101, ultimately of zero depth. The depth of the notches provides clearance for the valves as the piston is rotated to adjust the engine's compression ratio. The slope of the taper matches the pitch of the adjustment threads on the piston's interior bore wall. The notches are shaped to accommodate the shape of the bottom of the valves.

Thus, the invention provides means for adjusting the compression ratio of an engine either dynamically as the engine is running or while the engine is turned off. A vehicle's computer system can take various engine sensor readings and increase or decrease compression by sending appropriate signals to the stepper motor.

Although the invention has been described in detail with a few exemplary versions, other versions are possible. For example, the compression adjustment schemes shown can be adapted for use with other cylinder arrangements, such as with the banks of V-engines or with opposed-piston engines, or even with engines having circularly arranged cylinders. As another example, individual master spur gears engaging the pistons at each cylinder and driven separately or geared together could be used to adjust the compression ratio. So, as these few examples suggest, the scope of the invention is not meant to be limited to the example versions described in detail.

What is claimed is:

1. A variable-compression engine comprising:
a cylinder defining a cylinder axis;
a piston movable back and forth in the cylinder and having a skirt extending between a closed top end of the piston and an open bottom end, the skirt forming an interior face with a helically threaded portion and an exterior face having a toothed structure in the form of circumferentially spaced teeth extending parallel to the cylinder axis;
an adapter for connecting to an end of a connecting rod, the adapter having helical threads engaging the threaded portion of the interior face of the piston skirt;
compression adjustment means for engaging the teeth on the exterior face of the piston skirt to rotate the piston in the cylinder helically on the helical threads of the adapter to adjust the compression ratio of the cylinder.

2. An engine as in claim 1 wherein the compression adjustment means comprises a rack gear having teeth meshing with the teeth on the exterior face of the piston skirt.

3. An engine as in claim 1 wherein the compression adjustment means comprises:
a collar defining a central bore and an outer periphery, wherein the collar receives the piston in the bore and includes:
internal teeth bounding the central bore and mating with the toothed structure on the exterior face of the piston skirt, and
external teeth on the periphery of the collar; and
a gear having teeth engaging the external teeth to rotate the collar and thereby the piston to adjust the compression ratio of the cylinder.

4. An engine as in claim 3 wherein the collar is made of a nylon material.

5. An engine as in claim 3 wherein the gear is a worm gear.

6. An engine as in claim 1 wherein the compression adjustment means comprises a timing belt extending partway around the piston and having teeth regularly spaced to mate with the teeth on the exterior face of the piston skirt.

7. An engine as in claim 6 wherein the teeth on the timing belt are made of a nylon material.

8. An engine as in claim 6 wherein the compression adjustment means further comprises a roller bearing against the timing belt to maintain the timing belt's engagement with the piston.

9. An engine as in claim 1 wherein the compression adjustment means comprises a stepper motor operable to selectively rotate the piston.

10. An engine as in claim 1 wherein the piston includes a piston head at the closed top end with a spiral notch to avoid contact with a valve.

11. An engine as in claim 1 comprising a plurality of individual cylinders, pistons, and adapters, wherein the compression adjustment means simultaneously engages the teeth on the exterior faces of more than one of the pistons.

12. A variable-compression engine comprising:
a cylinder defining a cylinder axis;
a piston reciprocatable in the cylinder along the cylinder axis and having a cylindrical skirt extending between a closed top end of the piston and an open bottom end, the skirt bounding a threaded interior bore and having a geared exterior;
an adapter for connecting to an end of a connecting rod, the adapter having helical threads and being threadedly received in the threaded interior bore;
an adjustment gear meshing with the geared exterior of the skirt and selectively actuated to apply a tangential force to the piston skirt to rotate the piston in the cylinder helically on the helical threads of the adapter to adjust the compression ratio of the cylinder.

13. An engine as in claim 12 wherein the adjustment gear is a rack gear having teeth meshing with the geared exterior of the piston skirt.

14. An engine as in claim 12 wherein the adjustment gear comprises:
a collar defining a central bore and an outer periphery, wherein the collar receives the piston in the bore and includes:
internal teeth bounding the central bore and mating with the geared exterior of the piston skirt, and
external teeth on the periphery of the collar; and
a drive gear having teeth engaging the external teeth to rotate the collar and thereby the piston to adjust the compression ratio of the cylinder.

15. An engine as in claim 14 wherein the drive gear is a worm gear.

16. An engine as in claim 12 wherein the adjustment gear comprises a timing belt extending partway around the piston and having teeth regularly spaced to mate with the geared exterior of the piston skirt.

17. An engine as in claim 16 further comprising a roller bearing against the timing belt to maintain the timing belt mated with the geared exterior of the piston skirt.

18. An engine as in claim 12 further comprising a stepper motor coupled to the adjustment gear operable to selectively rotate the piston.

19. An engine as in claim 12 wherein the piston includes a piston head at the closed top end with a spiral notch to avoid contact with a valve.

20. An engine as in claim 12 comprising a plurality of individual cylinders, pistons, and adapters, wherein the adjustment gear simultaneously engages the geared exteriors of more than one of the pistons.

21. A variable-compression engine comprising:
a cylinder having a closed head end;
a piston reciprocatable in the cylinder in a stroke direction between a top dead center position nearer the head end of the cylinder and a bottom dead center position farther from the head end, the piston having a top end nearer the head end of the cylinder and a cylindrical skirt bounding a threaded interior bore terminating in a blind end at the top end of the piston, the skirt having an exterior with a plurality of circumferentially spaced elongated teeth extending parallel to the stroke direction and defining parallel channels between consecutive teeth;
a cylindrical adapter for connecting to an end of a connecting rod, the cylindrical adapter having threads on a cylindrical periphery and threadedly received in the threaded interior bore of the piston;
a plurality of drive lugs separated by gaps and arranged to engage the exterior of the piston skirt with one or more of the drive lugs each received in an individual channel and one or more of the teeth each received in an individual gap to allow the piston to reciprocate in the stroke direction along the drive lugs,
wherein the drive lugs are selectively moved to apply a tangential force on the skirt of the piston by pushing against the elongated teeth, the selectively applied tangential force causing the piston to rotate in the cylinder and ride along the threads of the cylindrical adapter to change the top and bottom dead center positions of the piston.

22. An engine as in claim 21 wherein the drive lugs are teeth formed on a rack gear.

23. An engine as in claim 21 comprising:
a collar defining a central bore and an outer periphery, wherein the collar receives the piston in the bore and includes:
internal teeth forming the drive lugs engaging the elongated teeth on the exterior of the piston skirt, and
external teeth on the periphery of the collar; and
a drive gear having teeth engaging the external teeth to rotate the collar and thereby the piston to adjust the compression ratio of the cylinder.

24. An engine as in claim 23 wherein the drive gear is a worm gear.

25. An engine as in claim 21 wherein the drive lugs are teeth formed on a timing belt extending partway around the piston.

26. An engine as in claim 25 further comprising a roller bearing against the timing belt to hold the timing belt against the piston skirt.

27. An engine as in claim 21 wherein the drive lugs are made of a nylon material.

28. An engine as in claim 21 wherein the piston includes a piston head at the top end with a spiral notch to avoid contact with a valve.

29. A variable-compression engine comprising:
a cylinder defining a cylinder axis;
a piston reciprocatable in the cylinder along the cylinder axis and having a cylindrical skirt extending between a closed top end of the piston and an open bottom end, the skirt bounding a threaded interior bore and having a plurality of teeth forming a spur gear centered on the cylinder axis;
an adapter for connecting to an end of a connecting rod, the adapter having helical threads and being threadedly received in the threaded interior bore of the piston;
an adjustment gear meshing with the spur gear and selectively actuated to rotate the piston in the cylinder helically on the helical threads of the adapter to adjust the compression ratio of the cylinder.

30. An engine as in claim 29 wherein the adjustment gear is a rack gear and the spur gear operates as an associated pinion gear.

31. An engine as in claim 29 wherein the adjustment gear comprises:
a collar defining a central bore and an outer periphery, wherein the collar receives the piston in the bore and includes:
internal teeth mating with the spur gear on the piston skirt, and external teeth on the periphery of the collar; and
a drive gear having teeth engaging the external teeth to rotate the collar and thereby the piston to adjust the compression ratio of the cylinder.

32. An engine as in claim 31 wherein the drive gear is a worm gear.

33. An engine as in claim 29 wherein the adjustment gear comprises a timing belt extending partway around the piston and having teeth regularly spaced to mate with the spur gear on the piston skirt.

34. An engine as in claim 33 further comprising a roller bearing against the timing belt to hold the timing belt against the piston.

35. An engine as in claim 29 wherein the piston includes a piston head at the closed top end with a spiral notch to avoid contact with a valve.

36. A variable-compression engine comprising:
a cylinder;
a crankshaft;
an adapter having a wrist pin and a threaded periphery;
a connecting rod connected at a first end to the wrist pin and at a second end to the crankshaft;
a piston including a skirt forming a spur gear surrounding a threaded piston bore, wherein the piston is threaded onto the adapter and received in the cylinder with the second end of the connecting rod extending from the bore and the cylinder to the crankshaft;
wherein rotation of the spur gear causes the piston to ride along the threads of the adapter to adjust the distance between the piston and the second end of the connecting rod.

37. An engine as in claim 36 further comprising a selectively driven rack gear meshing with the spur gear and wherein the spur gear operates as an associated pinion gear.

38. An engine as in claim 36 further comprising:
a collar encircling the piston around the skirt and including:
internal teeth mating with the spur gear on the piston skirt, an outer circumference, and external teeth formed on the outer circumference of the collar; and
a drive gear having teeth engaging the external teeth to rotate the collar and thereby the piston.

39. An engine as in claim 38 wherein the drive gear is a worm gear.

40. An engine as in claim 36 further comprising a timing belt extending partway around the piston and having teeth spaced to mate with the spur gear on the piston skirt.

41. An engine as in claim 40 further comprising a roller bearing against the timing belt to hold the timing belt against the piston.

42. An engine as in claim 36 wherein the piston includes a piston head with a spiral notch to avoid contact with a valve.

43. A variable-compression engine comprising:
a piston defining an axis and including a skirt having a helically threaded region formed along an interior of the skirt;
an adapter for attaching to an end of a connecting rod, the adapter having a threaded periphery engaged with the helically threaded region of the piston skirt and displaceable axially relative to the piston in the threaded region by rotation of the piston about the axis and the threaded movement of the piston on the adapter.

44. An engine as in claim 43 wherein the piston skirt includes a geared exterior.

45. An engine as in claim 44 further comprising a selectively driven rack gear meshing with the geared exterior of the piston skirt.

46. An engine as in claim 44 further comprising:
a collar encircling the piston around the skirt and including:
internal teeth mating with the geared exterior of the piston skirt, an outer circumference, and external teeth formed on the outer circumference of the collar; and
a drive gear having teeth engaging the external teeth to rotate the collar and thereby the piston.

47. An engine as in claim 46 wherein the drive gear is a worm gear.

48. An engine as in claim 44 further comprising a timing belt extending partway around the piston and having teeth spaced to mate with the geared exterior of the piston skirt.

49. An engine as in claim 48 further comprising a roller bearing against the timing belt to hold the timing belt against the piston.

50. An engine as in claim 43 wherein the piston includes a piston head with a spiral notch to avoid contact with a valve.

51. A piston for a variable-compression engine, the piston comprising:
a piston head at one end;
an open bottom at the other end;
a piston skirt extending axially between the piston head and the open bottom and having an interior face with a helically threaded portion and an exterior face with a toothed structure in the form of parallel, circumferentially spaced teeth separated by axial channels.

52. A piston as in claim 51 further including a pair of spiral notches formed in the piston head.

53. A method for varying the compression ratio of an engine, comprising:
providing an engine with a piston having a skirt with internal threads;
coupling one end of a connecting rod to the piston by pinning the end to an adapter threaded into the internal threads of the piston skirt;
rotating the piston to move it along the threads to vary the piston's position relative to the adapter and the end of the connecting rod.
